(19) United States
(12) Patent Application Publication
(10) Pub. No.: US 2015/0090524 A1
(43) Pub. Date: Apr. 2, 2015

(54) METHOD FOR PRODUCING FOAM PANELS, ESPECIALLY FOR THE FIELD OF AERONAUTICS

(71) Applicant: AIRCELLE, GONFREVILLE L'ORCHER (FR)

(72) Inventors: Didier LERETOUR, MANNEVILLETTE (FR); Alain ROUSSEL, Octeville-Sure-Mer (FR); Xavier DUPONT, Melamare (FR)

(21) Appl. No.: 14/566,987

(22) Filed: Dec. 11, 2014

Related U.S. Application Data
(63) Continuation of application No. PCT/FR2013/051346, filed on Jun. 11, 2013.

(30) Foreign Application Priority Data
Jun. 12, 2012 (FR) 12/55505

(51) Int. Cl. B64D 29/00; B29C 45/14; B29C 70/30; B29C 45/16

(52) U.S. Cl. CPC B64D 29/00; B29C 45/1657; B29C 45/1671; B29C 45/14786; B29C 70/30; B29C 2045/1659; B29C 2045/1692; B29L 2009/00
USPC 181/284; 264/257; 264/258

(57) ABSTRACT

The present disclosure is related to a method for producing a cellular panel which includes a cellular structure sandwiched between first and second stiff skins. The method includes the following steps: preparing at least two blocks of cellular material; disposing the two blocks on a base ply of dry fabric, while maintaining a space between the two blocks; folding the base ply around the two blocks so as to envelop the two blocks; filling in the space with a reinforcing ply; covering the base ply with a covering ply, on a side where the reinforcing ply has been introduced; injecting resin to an assembly obtained in the previous step; and curing the assembly.

### CROSS-REFERENCE TO RELATED APPLICATIONS

This application is a continuation of International Application No. PCT/FR2013/051346, filed on Jun. 11, 2013, which claims the benefit of FR 12/55505, filed on Jun. 12, 2012. The disclosures of the above applications are incorporated herein by reference.

### FIELD

The present disclosure relates to producing cellular panels for the field of aeronautics.

### BACKGROUND

The statements in this section merely provide background information related to the present disclosure and may not constitute prior art.

In the aeronautics field, it has been led to produce a certain number of parts from cellular panels.

By “cellular panel”, it is meant to be a panel formed of a cellular structure enclosed between two stiff skins.

The cellular structure is an aired structure, that is to say, formed of juxtaposed cells.

Such a cellular structure may be formed for example by polyethylene foam, or by a honeycomb type structure, formed with juxtaposed alveoli.

The advantage of such cellular panels is in particular, a very good resistance/weight ratio, rendering them particularly suitable for aeronautic applications.

Moreover, when piercing one of the skins with a multitude of holes, Helmholtz boxes may be obtained, resulting in an acoustic absorption effect: thus the cellular panels can be used inside the nacelles for aircraft turbojet engines in order to reduce the intensity of acoustic emissions of these turbojet engines.

In a certain number of cases, it is important to be able to reinforce the resistance of such cellular panels: it is for example the case when it is required to achieve thrust reversal shutters for aircraft turbojet engines.

Such thrust reversal shutters, actuated by thrust reversal connecting rods when it is required to redirect towards the front of the aircraft part of the air flow generated by the turbojet engines, must be able to resist to very high air pressures.

In order to reach this resistance, reinforcements are fixed on the cellular panels which form these thrust reversal shutters.

It can be seen on FIG. 1 a first form of such a thrust reversal shutter of the prior art.

This shutter comprises in this instance a honeycomb structure 1 enclosed inside a structuring skin 3 and an acoustic skin 5 pierced with a multitude of holes.

This thrust reversal shutter can thus absorb part of the noise caused by the very high speed circulation of the air in the air stream in which this shutter is installed.

The structuring 3 and acoustic 5 skins are typically produced with composite materials, such as plies of fabric of glass and/or carbon fibers taken in the polymerized resin.

An angle 7, formed in a metal alloy or in composite material, is added to the outside of the structuring skin 3, by gluing and/or riveting.

In a second alternative of the prior art, illustrated in FIG. 2, the angle 7 is added to the inside of the structuring skin 3, also by gluing and/or riveting.

Each of these two alternatives of the prior art gives rise to a certain number of technical issues.

Thus, for example, in the case of the alternative of FIG. 1, the angle 7 encumbers the external envelop of the thrust reversal shutter, and it is liable to become detached in the event of outside impact.

In the case of the alternative of FIG. 2, it is essential to machine the honeycomb structure 1 in order to be able to place and fix the foot of the angle 7 on the internal face of the structuring skin 3.

Moreover, in these two alternatives, when the angle 7 is in composite material, it must be pre-produced before being installed on the thrust reversal shutter, such that several cycles of curing must be considered to form the entirety of the part.

### SUMMARY

The present disclosure provides a method for producing a cellular panel comprising a cellular structure sandwiched between the first and second stiff skins, characterized in that it comprises the following steps:

preparing at least two blocks of cellular material,

disposing these two blocks on at least one ply of dry fabric called “base ply”, by maintaining a space between these two blocks,

folding this base ply around these two blocks in such a manner as to envelop them,

filling in the space between the two blocks with at least one ply of “reinforcing” fabric,

covering the base ply with at least one ply of dry or fresh “covering” fabric, on the side where the reinforcing ply has been introduced,

injecting the assembly thus obtained with resin, and

curing the assembly thus obtained.

Thanks to this method, the cellular panel reinforcement is obtained by adding plies of fabric in the space separating the blocks of cellular material, then by curing in one operation of the assembly of blocks of cellular material enveloped in the plies of fabric.

In this manner, it is obtained a reinforced cellular panel not requiring the addition of external parts, in which the reinforcing elements are incorporated, and able to be cured in one single operation: it consists in a way of a “box” structure, being all at once highly resistant, not comprising protuberant elements and being particularly easy to produce.

According to other features of this method according to the present disclosure:

the base ply is pierced subsequently in such a manner as to obtain an acoustic absorption panel;

said reinforcing ply is formed by an overlength of at least one end of said base ply;

said reinforcing ply is formed by overlengths of two ends of said base ply;

said reinforcing ply is formed by a ply distinct from said base ply;

said reinforcing ply is formed in dry fabric;

said reinforcing ply is formed in fresh fabric;

several base plies are superposed;

several reinforcing plies are superposed;

several covering plies are superposed;

a method of resin injection by infusion is used.

The present disclosure also relates to a cellular panel obtained by a method in compliance with what precedes, as well as a nacelle for aircraft turbojet engine equipped with at least one cellular panel in compliance with what precedes.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 are perspective views of two alternative forms of reinforced cellular panels of the prior art, described in the preamble of the present description;

FIGS. 3 and 4 are perspective views respectively of the upper surface of airfoil and the under surface of airfoil of a thrust reversal shutter achieved with the method according to the present disclosure;

FIGS. 5 to 7 are sectional schematic views of the different steps of producing a panel according to a first form of the method according to the present disclosure; and

FIG. 8 is a sectional view of a cellular panel achieved according to a second form of the method according to the present disclosure.

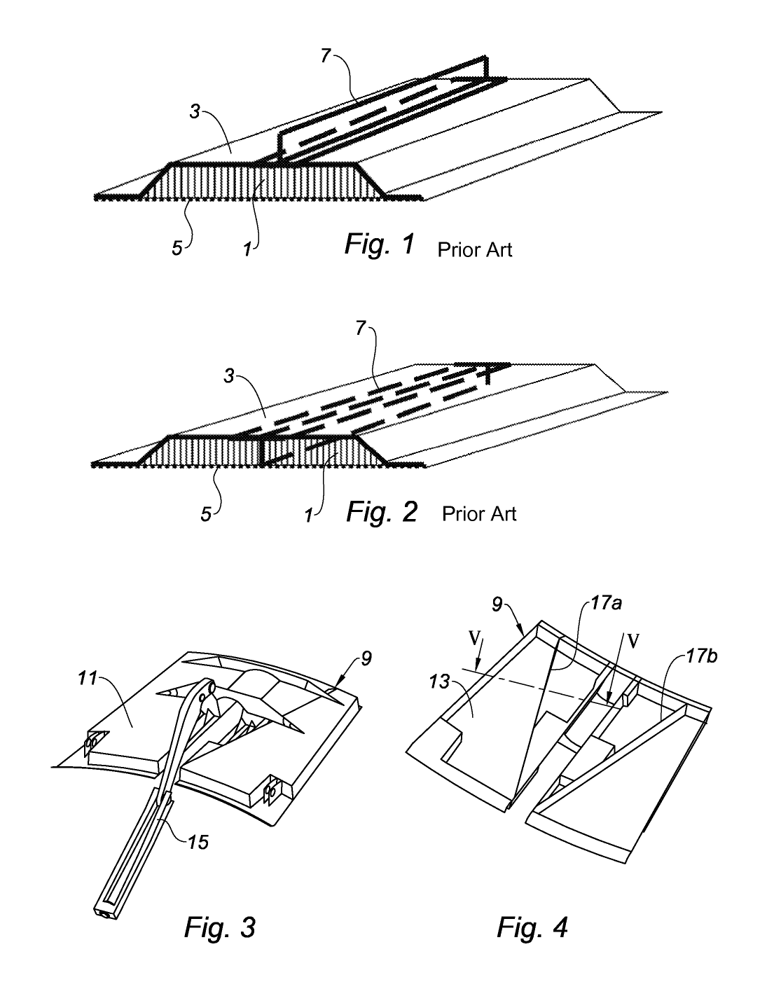

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference is now made to FIGS. 3 and 4 on which a thrust reversal shutter 9 has been represented, intended to equip a thrust reverser for aircraft.

This thrust reversal shutter 9 exhibits a general shape of trapezoidal plate which is slightly curved, comprising an upper surface of airfoil 11 and an under surface of airfoil 13.

The under surface of airfoil 13 is the face of the shutter 9 which is intended to be in contact with the cold air flow generated by the turbojet engine fan, in both direct jet and reverse jet mode.

In direct jet mode, the under surface of airfoil 13 forms the external wall of the stream of cold air of the thrust reverser, and allows streaming of this cold air downstream of the turbojet engine, thus supplying the thrust required for the propulsion of the aircraft.

In reverse jet mode, the thrust reversal shutter 9 hinders the stream of cold air, in such a manner that the under surface of airfoil 13 redirects the main part of the cold air flow upstream of the thrust reverser, allowing to contribute to the braking of the aircraft during landing.

Hence, it is understood that the under surface of airfoil 13 is the “active” surface of the reversal shutter 9, that is to say, the surface which should exhibit satisfactory aerodynamic and/or acoustic absorption features.

It is worth noting, as is known per se, that the actuating of the reversal shutter 9 between these direct jet and reverse jet positions is triggered by the thrust reversal connecting rod 15.

The thrust reversal shutter 9 is achieved by means of the method according to the present disclosure, and thus comprises inner reinforcing elements 17a, 17b, achieved in compliance with the method according to the present disclosure, as it will be described hereinafter.

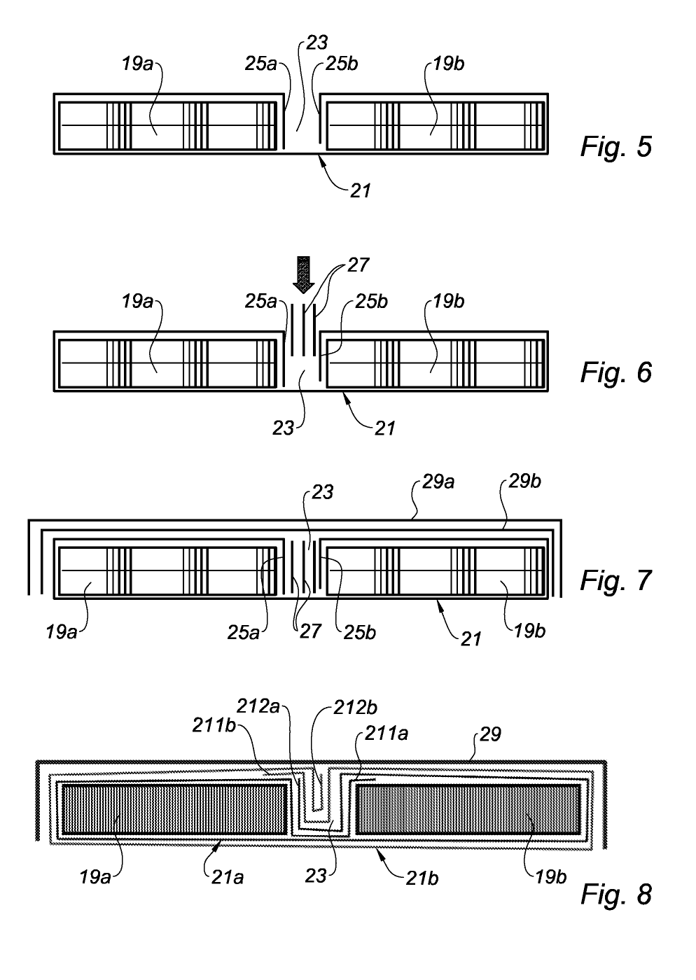

Reference is made to FIGS. 5, 6 and 7, on which the different steps of producing the shutter 9 can be seen, in the area of the cutting line V-V of FIG. 4.

As it can be seen on FIG. 5, it is started by disposing two blocks 19a, 19b, of cellular material, such as honeycomb structures, on a ply of dry fabric 21, by maintaining a space 23 between these two blocks 19a and 19b.

It is to be noted here that “ply” means a layer of fabric of fibers, such as carbon or glass fibers, intended to be impregnated with a heat polymerizable resin.

Once the two blocks 19a and 19b are placed on the base ply 21 as indicated in FIG. 5, the two ends 25a and 25b of this base ply 21 are folded, in such a manner as to envelop the two blocks of cellular material 19a and 19b.

At the following step, visible on FIG. 6, a plurality of “reinforcing” plies are inserted in the space 23 preserved between the two blocks 19a and 19b.

It is worth noting that these plies 27 may be dry plies, that is to say, of fibers without resin, or fresh plies, that is to say plies pre-impregnated with resin.

Once these reinforcing plies 27 are inserted in the space 23, it is covered the face of the thus formed assembly, by which the reinforcing plies 27 are introduced, with at least one, and preferably a plurality 29a, 29b of dry or fresh “covering” plies 29a, 29b.

Then, the assembly thus obtained is injected with a polymerizable resin, such as a polyimide resin, and the assembly thus injected is cured in an autoclave, in such a manner as to polymerize the resin and harden the assembly.

The resin injection method may be for example a method of resin transfer molding RTM type.

As can be understood in light of what precedes, the method which has just been described of achieving the reinforcements 27 of the cellular panel is very simple to implement.

In fact, this method comprises the placing plies according to a suitable sequence and geometry, the assembly being afterwards cured in one single step once this placing is achieved.

Contrary to the reinforced cellular panel of the prior art, no machining of the blocks of alveolar material 19a, 19b is necessary; no gluing or riveting is necessary either, and no reinforcing element exceeds the envelop volume of the end part.

Obviously, the number of base 21, reinforcing 27 and covering 29a, 29b plies, is in no way limited to the forms represented: the number of superposed plies may in fact vary according to the needs and sought mechanical features.

In the form exhibited on FIG. 8, two base plies 21a, 21b, and a single covering ply 29 are used.

Unlike the previous form, overlengths are used, respectively 211a, 211b, and 212a, 212b of the base plies 21a and 21b, which overlengths are disposed in a U shape in the space 23 separating the two blocks of cellular material 19a and 19b.

These overlengths of the base plies 21a and 21b can hence be a substitute to in this instance the reinforcing ply 27 of the previous form.

If it is required that the cellular panel thus obtained fulfills an acoustic absorption function, as it is generally the case of the thrust reversal shutters, the base plies 21 or 21a, 21b may of course be pierced, in such a manner that the alveoli of the blocks of cellular material 19a and 19b may communicate with the cold air intended to pass along the under surface of airfoil 13 of the thrust reversal shutter.

Each block of cellular material 19a, 19b may be itself constituted of a stacking of honeycombed structure, in such a manner as to achieve an optimal acoustic absorption (SDOF or DDOF acoustic absorption structure) for simple degree of freedom, or double degree of freedom.

Obviously, the present disclosure is in no way limited to the forms described and represented, provided by way of mere examples.

Thus, the cellular panels achieved thanks to the method according to the present disclosure could equip any other parts of a nacelle for an aircraft turbojet engine, and exhibit or not acoustic absorption features.

The method according to the present disclosure could also be used to produce cellular panels intended for parts of an aircraft other than nacelles.

What is claimed is:

1. A method for producing a cellular panel comprising a cellular structure sandwiched between first and second stiff skins, said method comprising the following steps:
preparing at least two blocks of cellular material;
disposing said at least two blocks on at least one base ply of dry fabric, while maintaining a space between said two blocks;
folding said at least one base ply around said two blocks so as to envelop said two blocks;
filling in the space with at least one reinforcing ply;
covering said base ply with at least one covering ply, on a side where said at least one reinforcing ply has been introduced;
injecting resin to an assembly obtained in the previous step; and
curing the assembly.

2. The method according to claim 1, wherein said at least one base ply is pierced subsequently so as to obtain an acoustic absorption panel;

3. The method according to claim 1, wherein said at least one reinforcing ply is formed by an overlength of at least one end of said at least one base ply.

4. The method according to claim 2, wherein said at least one reinforcing ply is formed by overlengths of two ends of said at least one base ply.

5. The method according to claim 1, wherein said at least one reinforcing ply is formed by a ply distinct from said at least one base ply.

6. The method according to claim 5, wherein said at least one reinforcing ply is formed in dry fabric.

7. The method according to claim 5, wherein said at least one reinforcing ply is formed in fresh fabric.

8. The method according to claim 1, wherein a plurality of base plies are superposed.

9. The method according to claim 1, wherein a plurality of reinforcing plies are superposed.

10. The method according to claim 1, wherein a plurality of covering plies are superposed.

11. The method according to claim 1, wherein a method of resin injection by infusion is used.

12. The method according to claim 1, wherein said at least one covering ply is a dry ply.

13. The method according to claim 1, wherein said at least one covering ply is a fresh ply.

14. The method according to claim 1, wherein the assembly is cured in an autoclave.

15. A cellular panel obtained by the method according to claim 1.

16. A nacelle for aircraft turbojet engine equipped with at least one cellular panel according to claim 15.
